(19) United States
(12) Patent Application Publication
(10) Pub. No.: US 2021/0326177 A1
(43) Pub. Date: Oct. 21, 2021

(54) QUEUE SCALING BASED, AT LEAST, IN PART, ON PROCESSING LOAD

(71) Applicant: Intel Corporation, Santa Clara, CA (US)

(72) Inventors: Anil VASUDEVAN, Portland, OR (US); Sridhar SAMUDRALA, Portland, OR (US); Kiran PATIL, Portland, OR (US); Amritha NAMBIAR, Portland, OR (US); Parthasarathy SARANGAM, Portland, OR (US)

(21) Appl. No.: 17/359,547

(22) Filed: Jun. 26, 2021

(51) Int. Cl. G06F 9/48; G06F 9/52

(52) U.S. Cl. CPC G06F 9/4881; G06F 9/526

(57) ABSTRACT

Examples described herein relate to one or more processors that execute a number of polling threads based on a number of queue identifiers, wherein at least one of the queue identifiers is associated with one or more queues. In some examples, the one or more processors selectively adjust a number of queue identifiers based on a load level of a queue. In some examples, the load level of a queue indicates a number of packets processed per unit of time. In some examples, the number of queue identifiers is no more than a number of configured queues. In some examples, the one or more queues are associated with a queue exclusively allocated to a thread for reading or writing.

Application Device Queue (ADQ) can accelerate processing of packets received through multiple connections by a central processing unit (CPU) core by grouping connections together under the same NAPI_ID identifier and avoiding locking or stalling from contention for queue accesses (e.g., reads or writes). ADQ can reduce network traffic arising from different applications or processes attempting to access the same queue and cause locking or contention, which can increase latency of packet availability and make packet availability unpredictable. Moreover, ADQ provides quality of service (QoS) control for dedicated application traffic queues for received packets or packets to be transmitted. ADQs can use busy polling to reduce packet processing latency and jitter. Busy polling can be a static configuration whereby with some busy polling configurations, a one-to-one mapping between queues and threads is made, so that with x queues and x threads, x cores are fully consumed, independent of the load. In other words, regardless of packet processing throughput in terms of transactions/second, x cores are utilized even if fewer cores can be used such as for P50, P90, or P99 service level agreement (SLA) latency parameters.

Some solutions, such as Shenango (described for example in Amy Ousterhout, Joshua Fried, Jonathan Behrens, Adam Belay, and Hari Balakrishnan, “Shenango: Achieving High CPU Efficiency for Latency-sensitive Datacenter Workloads,” In Proceedings of the 16th USENIX Symposium on Networked Systems Design and Implementation (NSDI), Boston, Mass., February 2019) describes fast thread switching and moving busy polling functionality into a reduced number of separate worker threads that aggregate traffic for multiple applications. By moving busy polling to a reduced set of worker threads, predictable packet processing latency and jitter may not be achieved.

### BRIEF DESCRIPTION OF THE DRAWINGS

FIG. 1 depicts an example system.

FIG. 2 depicts an example of allocation of queue identifiers to queues.

FIGS. 3A and 3B depict examples of queue identifier decrease and increase.

FIG. 4 depicts an example process for managing a number of threads executed to process workloads.

FIG. 5 depicts a system.

### DETAILED DESCRIPTION

Technologies that provide a thread exclusive access to a queue in order to read or write from the queue can be used. Such technologies can be used by a network interface controller, storage device or pool, or memory device or pool. ADQ is an example of such technologies. For example, a network processing application, database or software defined storage (SDS) application can execute on one or more threads. A queue may be assigned for exclusive access by a specific application and/or a thread of an application. In some examples, the thread can perform busy polling and/or the application. In a system with one or more queues dedicated for exclusive access to a thread or core, an intermediate queuing system can expand or contract a number of queues indicated as available to threads or cores. A thread can represent a sequence of programmed instructions executed by a core or processor. When or after a load on a thread or core reaches or exceeds a first load threshold, an intermediate queuing system can release one or more queue identifiers (IDs) to one or more applications and the one or more applications can instantiate more polling threads to poll for traffic received on queues associated with the released one or more queue IDs. Similarly, when or after a load on a thread or core reaches or falls below a second load threshold, the intermediate queuing system can contract a number of available queue IDs to one or more applications and the one or more applications can reduce a number of polling threads to poll for traffic received on queues. Based on an indicated load on a queue, such as an amount of packets to process per second, an application can dynamically adjust an amount of core utilization by allowing more application threads to run to increase processing throughput or allow fewer application threads to run to reduce system utilization and allow more applications to be able to execute on a system.

One or more queues can be assigned a queue ID and the queue ID can be assigned to an application. An application can execute an application thread per queue ID and the application thread can poll for work from one or more queues associated with the queue ID.

Thread execution can be adjusted so that a thread executing on a first core can be migrated for execution on a second core. The first core can be allowed to enter a lower power state and multiple threads can execute on the second core. The thread that is migrated can retain an exclusive access to a queue, regardless of a core that executes the thread.

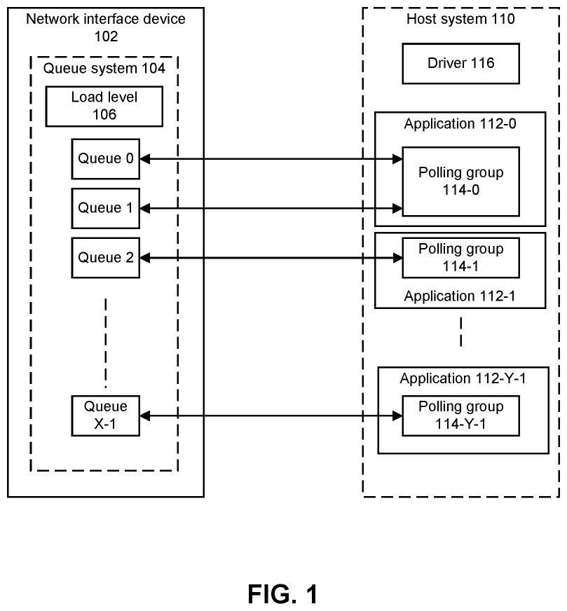

FIG. 1 depicts an example queue system. Network interface device 102 can utilize queue system 104 with queues 0 to X-1 available for access by threads executing applications 112-0 to 112-Y-1, where X and Y are integers. In some examples, queue system 104 is implemented as ADQ and network interface device 102 can allocate content to storage in one or more of queues 0 to X-1 in memory on network interface device 102 and/or on host system 110. For example, X queues can be assigned a unique NAPI_ID value. A thread running a polling group can be allocated a subset of N different NAPI_IDs, so that a polling group exclusively accesses a queue or queues associated with the allocated one or more NAPI_IDs and no other polling group accesses the queue or queues. Network interface device 102 can be any device including a hardware queue manager, host interface, fabric interface, and so forth.

In this example, applications 112-0 to 112-Y-1 can utilize polling groups 104-0 to 104-Y-1 to poll for new work or packets to process queues 0 to X-1. For example, polling group 104-0 can poll for work in queues 0 and 1, whereas polling group 104-1 can poll for work in queue 2, and so forth. In other words, a polling group can poll for work in one or multiple queues. Queues can be allocated to an application thread, and these queues can be exclusively accessed by thread(s) that execute associated applications. Polling groups 104-0 to 104-Y-1 can perform busy polling of queues directly to detect for whether packets are received and available for processing.

Applications 112-0 to 112-Y-1 can be implemented as a service, microservice, cloud native microservice, workload, or software. Applications 112-0 to 112-Y-1 can represent multiple threads executing of a same application. Applications 112-0 to 112-Y-1 can represent multiple threads executing of different applications. Applications 112-0 to 112-Y-1 can represent one or more devices, such as a field programmable gate array (FPGA), an accelerator, or processor. Any application or device can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

Driver 114 can provide a control plane to associate a queue identifier with one or more queues of queue system 104 and allocate queue identifiers to application threads. Driver 114 can allocate queue identifiers to applications 112-0 based on a load level of at least one queue. For example, load level 106 can indicate a number of work entries per queue, number of requests processed per second per queue, number of packets processed per second per queue, or other measures of processing activity. In some examples, a number of threads of an application executed can correspond to a number of queue identifiers. For example, if load level 106 indicates a load level of a particular queue meets or exceeds a threshold, then driver 116 can increase a number of queue identifiers for allocation to an application to cause more application threads to execute. For example, if load level 106 indicates a load level of a particular queue meets or is below a second threshold, then driver 116 can decrease a number of queue identifiers for allocation to an application to cause fewer application threads to execute.

Although examples are provided with respect to a network interface device, other devices can be used instead or in addition, such as a storage controller, memory controller, fabric interface, processor, and/or accelerator device.

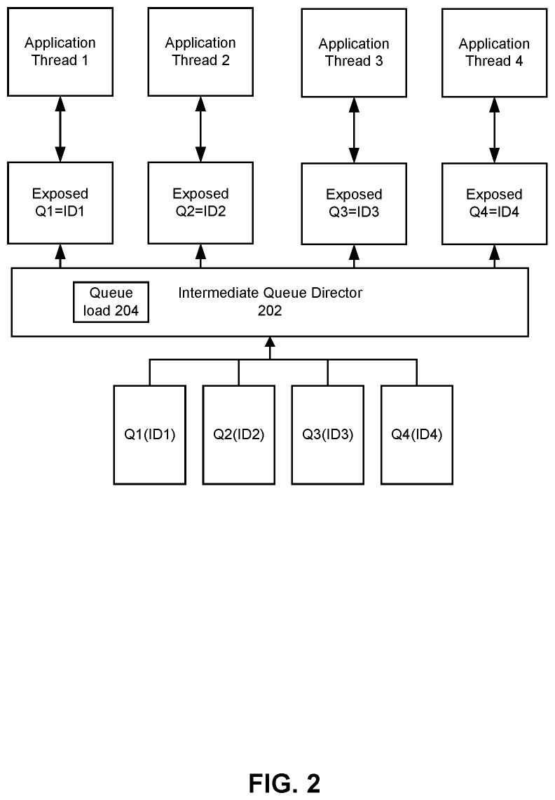

FIG. 2 depicts an example configuration. Intermediate queue director 202 can monitor loads on queues and signal to the application when a thread expansion or thread reduction is requested by indicating a number of available queue identifiers. Intermediate queue director 202 can manage availability of queue identifiers and expand or reduce a number of queue identifiers available to application threads based on a load level identified in queue load 204. For example, queue load 204 can indicate a rate of packet receipt or availability for processing in one or more of queues Q1 to Q4. In some examples, intermediate queue director 202 can be implemented as a driver for a network interface device or a queue system.

In this example, contents of four queues and corresponding queue identifiers (ID1, ID2, ID3, and ID4) are available to allocate to threads so that threads poll and process contents of associated queues. This scenario can represent a full utilization of available queues by providing availability of queue identifiers ID1 to ID4 to threads. An application can configure a number of active threads as a function of a number of available queues, which in this example is 4 threads. Threads 1 to 4 can poll and process contents of respective queues 1 to 4. In the example shown, a maximum number of threads are shown to be 4 and a different queue is allocated to each of the threads. When packet traffic arrives at a network interface device, packet traffic can be load balanced such as receive side scaling (RSS) into the 4 queues.

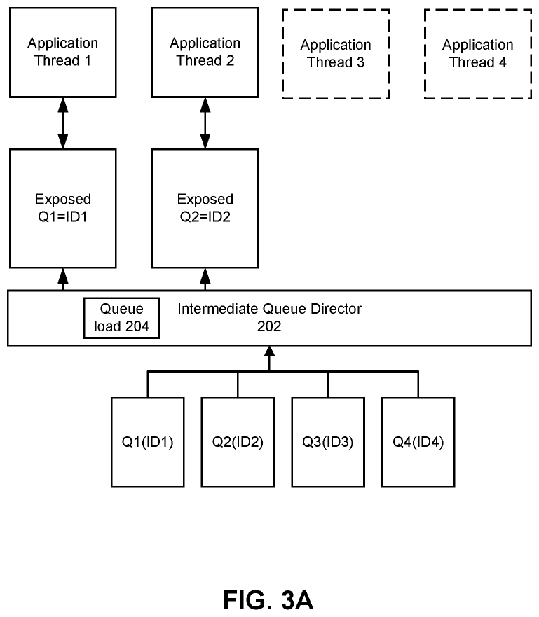

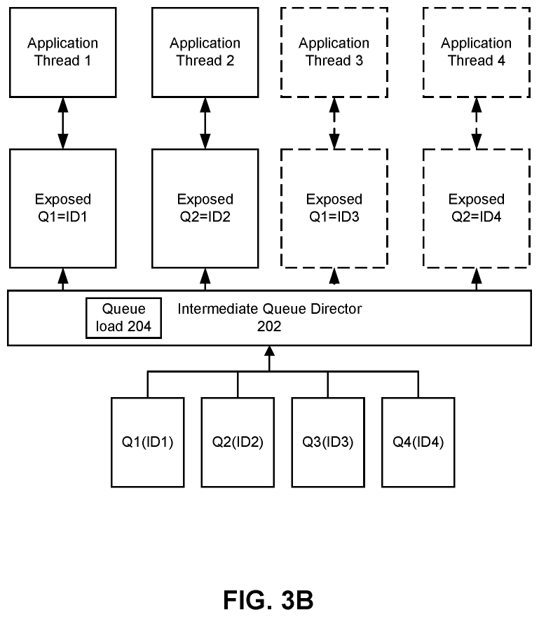

For example, if a single core is capable of handling a load of 100K packets/second. For 4 connections generating traffic of 50K packets/second to each of queues Q1-Q4, then two cores can adequately process incoming packet traffic. Intermediate queue director 202 can determine queue load 204 as 50K packets/second and scale down a number of exposed queues to only 2 of the 4 queueIDs to the application (QID1 and QID2). FIG. 3A depicts a scenario where a number of available queues to threads is reduced from 4 to 2. Application threads 1 and 2 can access queues associated with the queue identifiers ID1 and ID2. A thread can perform polling of one or more queues associated with a queue ID and/or process packets or data from the one or more queues. However, despite application threads 1 and 2 accessing packets associated with queue identifiers ID1 and ID2, queues Q1 to Q4 can continue to receive packets. Intermediate queue director 202 can set queue identifiers for queues Q1 and Q2 to ID1 and queue identifiers for queues Q3 and Q4 to ID2 and thread 1 can access packets from queues Q1 and Q2 whereas thread 2 can access packets from queues Q3 and Q4. However, queue identifiers can refer to different numbers of queues. For example, ID1 can refer to queues Q1-Q3 and ID2 can refer to queue Q4. However, any number of queues Q1-Q4 can be associated with a queueID.

Reducing a number of queue identifiers can include merging queue identifiers into a single queue identifier. For example, if Q1(ID1) and Q3(ID3) are to be merged into a single visible queue identifier Q1(ID1), assuming the combined traffic can be handled by a single application thread, intermediate queue director 202 can determine to provide packets received at Q3(ID3) to application thread 3 with a new queue ID, Q1(ID1). An eventing layer can identify a change in QID, Q1(ID1), on some packets, and pass this information to the application in the form of a QID change notification. Based on application Thread 3 detecting this notification, Thread 3 checks if there is another application thread tied with QID1. In this case, application Thread 1 is tied to QID1, and application Thread 3 removes descriptors associated with the QID Q1(ID1) from its event interest list and copies them on the event interest list associated with Application Thread 1 (and Q1(ID1)) for processing.

After the scenario of FIG. 3A, based on a queue load 204 indicating that a number of received packets/second are more than two threads can process, then intermediate queue director 202 can determine to increase a number of queues from 2 to 3 or 4. For example, received traffic of 120K packets/second, three cores can adequately process incoming packet traffic as each core can process 50K packets/second. For example, received traffic of 175K packets/second, four cores can adequately process incoming packet traffic as each core can process 50K packets/second.

FIG. 3B depicts an example of expanding a number of queues from 2 to 4. For example, in a case of an expansion of queues, a number of queue identifiers available or exposed to an application can be increased from ID1 and ID2 to ID1 to ID4. Queues Q1 to Q4 can be associated with respective queue identifiers ID1 to ID4.

Even though the network interface device copies data into four queues by direct memory access (DMA), an application detects only two of the queues, since all traffic is identified or stamped with Q1(ID1) or Q2(ID2), for queueIDs. As an example, intermediate queue director 202 may choose to combine Q1(ID1) and Q3(ID3) and expose QID1 as the source queue for traffic from either of these queues. Intermediate queue director 202 can monitor the total traffic from the underlying queues it combines, e.g., a total number of packets in queues QID1 and QID3, in this example for a total of 100K packets/second. If intermediate queue director 202 determines a load is reaching the maximum per core thresholds for a given queue ID, e.g., QID1, intermediate queue director 202 can expose QID3 or QID4 directly to application to cause an increase a number of threads available to process packets.

For example, if the load on the exposed Q1(ID1) is 150K packets/second, which exceeds 100K packets/second threshold, to relieve Q1(ID1) of the extra load, intermediate queue director 202 can separate the combination of Q1(ID1) and Q3(ID3) into two separately visible queues. When Q3(ID3) is made accessible, it is tied to application thread 1. As the packet traverses up the stack, a new QID, Q3(ID3), is detected (compared to previous Q1(ID1)). This information is passed to the application, in the form of a QID change notification. This change notification can inform the application thread that there are some descriptors (e.g., socket descriptors) requesting a new event interest list and thread association. The application checks if there is already another active thread associated with Q3(ID3) and if no other active thread is associated with Q3(ID3), the application identifies one of the dormant threads, e.g., thread 3, and configures a new event interest list for Thread 3 with descriptors that requested the change. Thread 1 can remove these descriptors from its own interest list and active thread 3 is to process data from a queue associated with Q3(ID3) to maintain a single producer-consumer model between the application thread and the queue(s) that it is sourcing data from. Similar operations can occur for Q2(ID2) and intermediate queue director 202 can separate the Q2(ID2) and Q4(ID4) combination.

A number of executing threads can be scaled based on a number of queue identifiers assigned to an application and/or processing capability of the core that executes the threads. However, a number of packets/second that a thread can process can depend on the processing capability of the core that executes the thread. A thread can be migrated to another core with similar or same processing capability as its former core or to a heterogeneous core with higher or lower processing capability as its former core. Accordingly, a number of threads to execute to process packets (or work) associated with a queue can depend on the capability of the core that executes the threads.

Note that for packet traffic that is to be transmitted, threads can utilize the same queue identifiers for queues as those used for packet receipt in order to associate packets to be transmitted with queue identifiers. One or more queues associated with a queue identifier can be used to store portions of a packet that is to be transmitted or received. In some examples, a same thread can process contents of received of one or more packets and generate content to transmit in one or more packets.

When a queue identifier (e.g., NAPI_ID) change occurs, either a queue identifier is added or a queue identifier is removed. An epoll fd can monitor two sets of descriptors: (1) standard socket descriptors for send/receive traffic to/from the network medium and (2) pipe descriptors used to communicate among the application threads. The following pseudo code illustrates an example epoll interface to react to event changes.

```
nfds = epoll_wait(epfd, events, MAX_EPOLL_EVENTS, timeout);
for (i = 0; i < nfds; ++i)
{
  /*Event change indication*/
  if ((events[i].events & EPOLLCHG) {
    Get the associated socket;
    Delete this socket from this epoll file descriptor (epfd);
    Pass on the change notification through to the new thread (e.g., a
pipe, being monitored via epoll on the new thread);
  }
  /*Event read indication*/
  else if ((events[i].events & EPOLLIN) {
    Perform a read operation on the socket or pipe descriptor ;
    If pipe descriptor, extract the socket file descriptor (fd) and add to
    this epfd;
    If regular socket descriptor, extract and act on message;
  }
}
```

Queue identifier numbers can be assigned to particular queues and queue identifier number changes can be propagated to the application. In a case of an expansion of queue identifiers, during polling, an event change indication of a new queue identifier can be detected, which can cause allocation of the new queue identifier by an application to a thread. In some cases, when an application starts, multiple threads can be launched but thread(s) that are not used can be quiesced. Where a new queue identifier is detected, a quiesced thread can be activated to poll from one or more queues associated with the new queue identifier. In a case where a number of queue identifiers shrinks or is reduced, a queue identifier can be removed and the thread associated with such removed queue identifier can eventually become a quiesced thread because of lack of work to process.

A likelihood of traffic interruptions or packet drops can be reduced because received packet traffic continues to be received at the same queues that are exposed at initialization and there may be no change in the queue that receives packet traffic, in the device driver to network interface device, or the socket queues where the network stack stores the packets.

Packets can be processed in order of receipt order where there is no change in the receive queues or any intermediate queue that would cause out of order packet receipt or processing. When a change notification is received on a given thread, that thread does not perform any processing of received packets on that socket but passes a change notification to a thread that is also being monitored by the epoll file descriptor (fd) associated with that thread. Subsequent packet receives and packet transmissions can occur using the new thread and in order packet processing can occur.

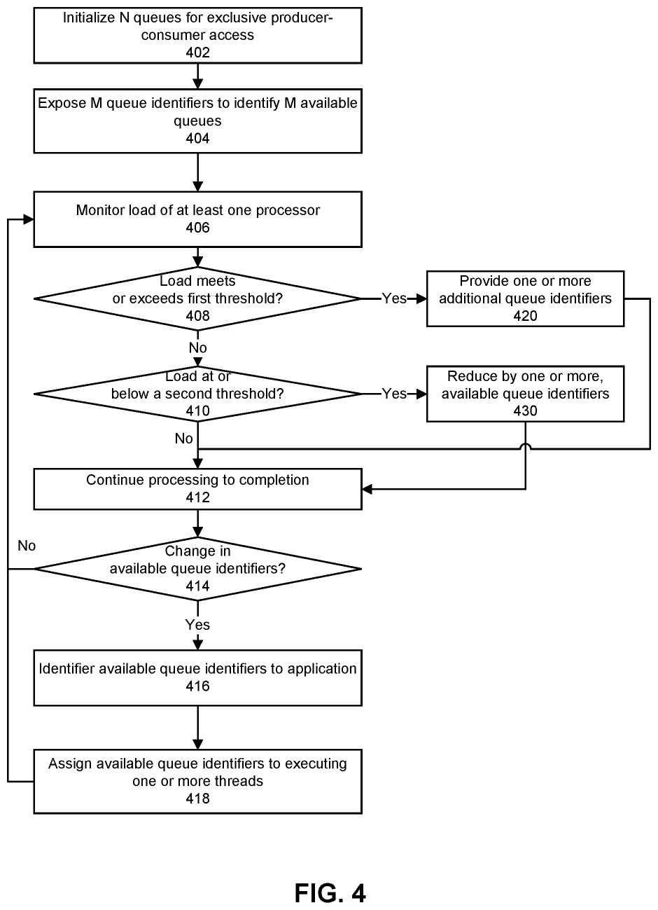

FIG. 4 depicts an example process for managing a number of threads executed to process workloads. At 402, N queues can be initialized and N application threads can execute and poll for events from the N queues. For example, events can correspond to receipt of one or more packets or other workloads.

At 404, M number of queue identifiers can be identified, where M≤N, so that M application threads are active. A queue identifier can correspond to one or more of the N queues. The number of application threads that are active can match a number of queue identifiers. One or more of the application threads can access respective event wait descriptors.

At 406, load on the active cores or threads can be observed by observing traffic on associated queues. At 408, a determination can be made as to whether a load level meets or exceeds first threshold. If a load level meets or exceeds first threshold, the process can continue to 420. At 420, one or more additional queue identifiers can be made available and associated with one or more of the queues. Increasing a number of available queue identifiers can cause an application to execute more threads, where a number of threads corresponds to or matches a number of queue identifiers. The process can continue to 412.

If a load level is less than the first threshold, the process can continue to 410. At 410, a determination can be made as to whether a load level is at or below second threshold. If a load level is at or below second threshold, the process can continue to 430. At 430, one or more queue identifiers can be made unavailable. Reducing a number of available queue identifiers can cause an application to execute fewer threads, where a number of threads corresponds to or matches a number of queue identifiers. If a load level is above the second threshold, the process can continue to 412.

At 412, processing of packets can occur to completion of packet processing to extract data and process data from received packets. Packet processing can include one or more of: execution of a microservice, service, application (e.g., database, video processing, or media transcoding), or other examples described herein.

At 414, a determination can be made of whether a change in an available queue identifier has occurred. If a change to an available queue identifier has occurred, the process can continue to 416. If a change to an available queue identifier has not occurred, the process can continue to 406.

At 416, available queue identifiers can be identified to an application. At 418, available queue identifiers can be assigned to one or more threads for processing. At 418, an application can access socket descriptors with available queue identifiers, including newly added or reduced set of queue identifiers, from an event interest list of the current thread and assign the queue identifiers to an available queue identifier list of a new thread. The new thread can process socket descriptors associated with this available queue interest list. Accordingly, changing a number of available queue identifiers can cause a change in a number of corresponding application threads to scale up or down processor utilization.

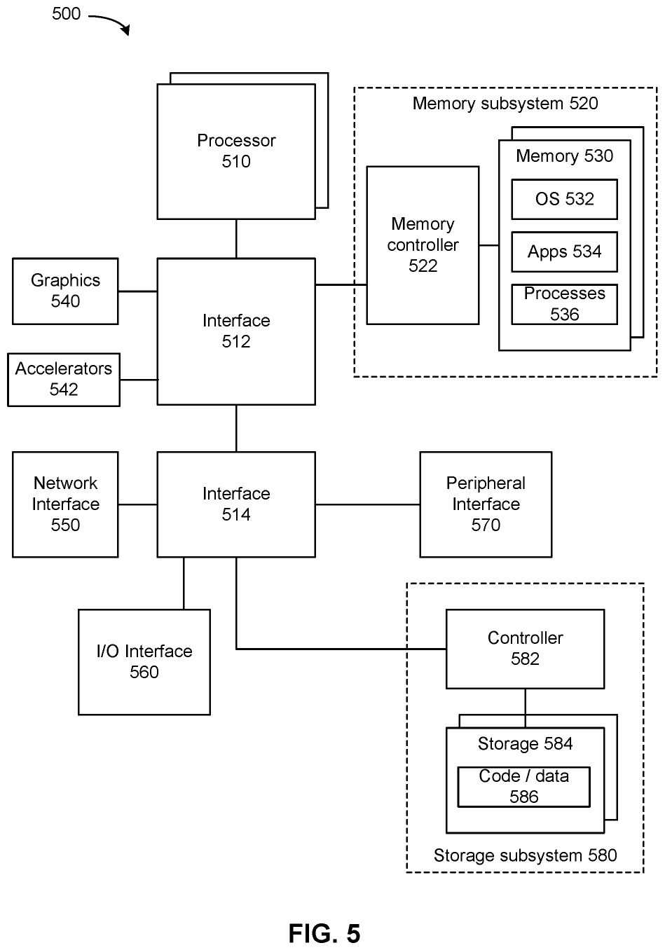

FIG. 5 depicts an example computing system. Components of system 500 (e.g., processor 510, network interface 550, and so forth) to determine core or thread utilization and allocate a number of queue identifiers to an application, as described herein. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a high definition (HD) display that provides an output to a user. High definition can refer to a display having a pixel density of approximately 100 PPI (pixels per inch) or greater and can include formats such as full HD (e.g., 1080 p), retina displays, 4K (ultra-high definition or UHD), or others. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a fixed function or programmable offload engine that can be accessed or used by a processor 510. For example, an accelerator among accelerators 542 can provide compression (DC) capability, cryptography services such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 542 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. In some examples, a driver can configure network interface 550 or other device to allocate a queue to an application thread, selectively adjust a number of allocated queue identifiers, allocate one or more queues allocated to a queue identifier, and allocate a number of queue identifiers to an application based on workload of an application thread, as described herein.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory.

Some examples of network interface 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. Dynamic volatile memory uses refreshing the data stored in the device to maintain state. One example of dynamic volatile memory includes DRAM (Dynamic Random Access Memory), or some variant such as Synchronous DRAM (SDRAM). An example of a volatile memory include a cache. A memory subsystem as described herein may be compatible with a number of memory technologies, such as DDR3 (Double Data Rate version 3, original release by JEDEC (Joint Electronic Device Engineering Council) on Jun. 16, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of one or more of the above, or other memory.

A power source (not depicted) provides power to the components of system 500. More specifically, power source typically interfaces to one or multiple power supplies in system 500 to provide power to the components of system 500. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writable or re-writable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes a computer-readable medium comprising instructions stored thereon, that if executed by one or more processors, cause the one or more processors to: execute a number of polling threads based on a number of queue identifiers, wherein at least one of the queue identifiers is associated with one or more queues.

Example 2 includes one or more examples, and includes instructions stored thereon, that if executed by one or more processors, cause the one or more processors to: selectively adjust a number of queue identifiers based on a load level of a queue.

Example 3 includes one or more examples, wherein the load level of a queue indicates a number of packets processed per unit of time.

Example 4 includes one or more examples, wherein the number of queue identifiers is no more than a number of configured queues.

Example 5 includes one or more examples, wherein the one or more queues are associated with a queue exclusively allocated to a thread for reading or writing.

Example 6 includes one or more examples, wherein the one or more queues are associated with a network interface device, accelerator, storage controller, memory controller, or processor.

Example 7 includes one or more examples, wherein the network interface device comprises one or more of: network interface controller (NIC), SmartNIC, router, switch, forwarding element, infrastructure processing unit (IPU), or data processing unit (DPU).

Example 8 includes one or more examples, and includes an apparatus comprising: circuitry, when operational, to execute a number of polling threads based on a number of queue identifiers, wherein at least one of the queue identifiers is associated with one or more queues.

Example 9 includes one or more examples, and includes circuitry to allocate the one or more queues for exclusive access by an application thread.

Example 10 includes one or more examples, wherein a number of queue identifiers is no more than a number of queues available for exclusive access.

Example 11 includes one or more examples, wherein: the application is to execute a number of polling threads based on the number of queue identifiers.

Example 12 includes one or more examples, wherein the circuitry, when operational, is to: selectively adjust the number of queue identifiers based on a load level of a queue.

Example 13 includes one or more examples, wherein the load level comprises a number of packets processed per unit of time in the one or more queues.

Example 14 includes one or more examples, wherein the one or more queues are associated with a network interface device, accelerator, storage controller, memory controller, or processor.

Example 15 includes one or more examples, wherein the network interface device comprises one or more of: network interface controller (NIC), SmartNIC, router, switch, forwarding element, infrastructure processing unit (IPU), or data processing unit (DPU).

Example 16 includes one or more examples, and includes a method comprising: executing a number of polling threads based on a number of queue identifiers, wherein at least one of the queue identifiers is associated with one or more queues.

Example 17 includes one or more examples, and includes selectively adjust a number of queue identifiers based on a load level of a queue.

Example 18 includes one or more examples, wherein the queue identifiers are associated with queues allocated exclusively for access to one or more application threads.

Example 19 includes one or more examples, and includes an application executing a number of polling threads based on the number of queue identifiers.

Example 20 includes one or more examples, wherein the number of queue identifiers is no more than a number of configured queues.

What is claimed is:

1. A computer-readable medium comprising instructions stored thereon, that if executed by one or more processors, cause the one or more processors to:
execute a number of polling threads based on a number of queue identifiers, wherein at least one of the queue identifiers is associated with one or more queues.

2. The computer-readable medium of claim 1, comprising instructions stored thereon, that if executed by one or more processors, cause the one or more processors to:
selectively adjust a number of queue identifiers based on a load level of a queue.

3. The computer-readable medium of claim 2, wherein the load level of a queue indicates a number of packets processed per unit of time.

4. The computer-readable medium of claim 1, wherein the number of queue identifiers is no more than a number of configured queues.

5. The computer-readable medium of claim 1, wherein the one or more queues are associated with a queue exclusively allocated to a thread for reading or writing.

6. The computer-readable medium of claim 5, wherein the one or more queues are associated with a network interface device, accelerator, storage controller, memory controller, or processor.

7. The computer-readable medium of claim 6, wherein the network interface device comprises one or more of: network interface controller (NIC), SmartNIC, router, switch, forwarding element, infrastructure processing unit (IPU), or data processing unit (DPU).

8. An apparatus comprising:
circuitry, when operational, to execute a number of polling threads based on a number of queue identifiers, wherein at least one of the queue identifiers is associated with one or more queues.

9. The apparatus of claim 8, comprising:
circuitry to allocate the one or more queues for exclusive access by an application thread.

10. The apparatus of claim 9, wherein a number of queue identifiers is no more than a number of queues available for exclusive access.

11. The apparatus of claim 9, wherein:
the application is to execute a number of polling threads based on the number of queue identifiers.

12. The apparatus of claim 8, wherein the circuitry, when operational, is to:
selectively adjust the number of queue identifiers based on a load level of a queue.

13. The apparatus of claim 12, wherein:
wherein the load level comprises a number of packets processed per unit of time in the one or more queues.

14. The apparatus of claim 8, wherein the one or more queues are associated with a network interface device, accelerator, storage controller, memory controller, or processor.

15. The apparatus of claim 14, wherein the network interface device comprises one or more of: network interface controller (NIC), SmartNIC, router, switch, forwarding element, infrastructure processing unit (IPU), or data processing unit (DPU).

16. A method comprising:
executing a number of polling threads based on a number of queue identifiers, wherein at least one of the queue identifiers is associated with one or more queues.

17. The method of claim 16, comprising:
selectively adjust a number of queue identifiers based on a load level of a queue.

18. The method of claim 16, wherein the queue identifiers are associated with queues allocated exclusively for access to one or more application threads.

19. The method of claim 16, comprising:
an application executing a number of polling threads based on the number of queue identifiers.

20. The method of claim 16, wherein the number of queue identifiers is no more than a number of configured queues.
